(19) United States
(12) Patent Application Publication
(10) Pub. No.: US 2019/0295832 A1
(43) Pub. Date: Sep. 26, 2019

(54) Member for use in mass spectrometer

(71) Applicant: SHIMADZU CORPORATION, Kyoto-shi (JP)

(72) Inventor: Hiroaki WAKI, Kyoto-shi (JP)

(73) Assignee: SHIMADZU CORPORATION, Kyoto-shi (JP)

(21) Appl. No.: 15/928,726

(22) Filed: Mar. 22, 2018

(51) Int. Cl. H01J 49/06; H01J 49/42

(52) U.S. Cl. CPC H01J 49/062; H01J 49/068; H01J 49/421

(57) ABSTRACT

A member is disposed along a flight path of ions in a mass spectrometer in which ions accelerated by an electric field are made to fly freely, and are separated and detected with respect to each mass-to-charge ratio depending on the time of flight taken by each ion to reach a detector. The member includes: a first portion having length L1 along the flight path; and a second portion disposed adjacent to the first portion along the flight path, is made of a material different from the material for the first portion, and has length L2 along the ion flight path. L1 and L2 are set to satisfy L1×α1+L2×α2=0, where α1 is the linear expansion coefficient of the material for the first portion along the flight path, and α2 is the linear expansion coefficient of the material for the second portion.

### TECHNICAL FIELD

The present invention relates to a member for use in forming a flight space for ions in a mass spectrometer.

### BACKGROUND ART

A time-of-flight mass spectrometer (TOFMS) has been known as one type of mass spectrometer. In the TOFMS, ions accelerated by an electric field are introduced into a flight tube from one end and are made to fly freely in the flight tube. Various ions are separated and detected with respect to each mass-to-charge ratio m/z, depending on the time of flight taken by each ion to reach a detector provided at the terminal end of the free-flight path.

The principle that various ions can be separated with respect to each mass-to-charge ratio m/z depending on the time of flight is premised on the constancy of the flight distance of the ions, while the flight distance is dependent on the length of the flight tube. If the length of the flight tube changes depending on the temperature, for example, the constancy of the flight distance cannot be secured. This decreases the accuracy in determining the mass-to-charge ratio m/z based on the time of flight.

In view of the above, various techniques have been proposed for avoiding changes in the length of the flight tube depending on the temperature. For example, it has been proposed that the flight tube be placed within a thermostatic chamber, the inside of which is kept at a constant temperature Patent Literature 1, for example). It has also been attempted to form the flight tube with a material having a small thermal expansion coefficient (one example is Invar®, which is an alloy of iron (Fe) and nickel (Ni)).

### CITATION LIST

### Patent Literature

Patent Literature 1: JP 2008-157671 A

### SUMMARY OF INVENTION

### Technical Problem

The method of placing a flight tube within a thermostatic chamber requires equipment for keeping the thermostatic chamber and its inside at a constant temperature (a heater, fan, temperature sensor, control unit that controls the temperature, and so on). With this method, an increase in the size and manufacturing cost of the mass spectrometer is inevitable. In addition, the temperature sensor disposed in the thermostatic chamber generates heat, and thus affects the temperature of the thermostatic chamber. It is not easy to allow for such an effect and yet perform the temperature control with high accuracy that ensures that the temperature of the thermostatic chamber is accurately kept at a constant level.

In contrast, if the flight tube is formed with a material having a small thermal expansion coefficient, such as invar, the length of the flight tube will not easily change depending on the temperature. However, even the use of invar does not mean that the thermal expansion coefficient becomes completely zero. Accordingly, even a flight tube made of invar undergoes a slight change in length depending on the temperature.

As mentioned above, no effective technique has been conventionally provided that can sufficiently prevent the change in length of the flight tube depending on the temperature.

In addition to the flight tube, the mass spectrometer includes other members that adversely affect analysis accuracy due to the change in their length depending on the temperature.

For example, the mass spectrometer may include an einzel lens as an ion-transport optical system for transporting ions to the flight tube. The ion-transport optical system using the einzel lens includes a plurality of (typically, three) electrodes arranged along a flight path of ions, and an insulation spacer disposed between the electrodes which are adjacent to each other, Here, if the length (along the flight path of ions) of the insulation spacer changes depending on the temperature, the constancy of the intervals between the electrodes cannot be secured. If the intervals between the electrodes change, a predetermined lens effect on the ions (specifically, for example, a predetermined acceleration) cannot be obtained. This adversely affects the analysis accuracy.

An object of the present invention is to provide a technique that can avoid the deterioration in analysis accuracy due to a temperature-dependent change in the length of a member used for forming a flight space of ions in a mass spectrometer.

### Solution to Problem

The present invention developed for solving the above problems is a member to be disposed along a flight path of ions in a mass spectrometer in which ions accelerated by an electric field are made to fly freely, and are separated and detected with respect to each mass-to-charge ratio depending on a time of flight taken by each ion to reach a detector, the member including:

a first portion having a length L1 along the flight path, and
a second portion that is disposed adjacent to the first portion along the flight path, is made of a material different from a material for the first portion, and has a length L2 along the flight path, wherein,
the length L1 and the length L2 are set so as to satisfy L1×α1+L2×α2=0,
where α1 is the linear expansion coefficient along the flight path of the material for the first portion, and α2 is the linear expansion coefficient along the flight path of the material for the second portion.

According to this mode of the present invention, in the member disposed along the ion flight path, when the length of the first portion (the length along the ion flight path) increases by ΔL due to thermal expansion, the length of the second portion (the length along the ion flight path) decreases by the same length, ΔL, due to thermal contraction (ΔL=L1×α1×Δθ=−L2×α2×Δθ, where Δθ is a change in temperature). Thus, the amount of thermal expansion of the first portion is cancelled by the amount of thermal contraction of the second portion. Accordingly, the total length of the member (the length along the ion flight path) does not change. Therefore, the deterioration in analysis accuracy of the mass spectrometer, which is caused by the change in length of the member disposed along the ion flight path depending on the temperature, can be avoided.

It is preferable, for the member for use in a mass spectrometer, that the thermal capacity of the first portion and the thermal capacity of the second portion are equal to each other.

According to this mode of the present invention, the thermal capacity of the first portion and that of the second portion are equal to each other. In this situation, for example, when the ambient temperature changes from θ1 to θ2, the speed of temperature change in the first portion becomes equal to that in the second portion. In other words, the temperatures of the first portion and the second portion are always kept approximately equal to each other, not only during a time period in which the temperatures of the first and the second portions are maintained at a constant level (an equilibrium time period), but also during a time period in which the temperatures of the first and the second portions are changing (non-equilibrium time period). If the thermal capacities of the first and the second portions are significantly different, one of the temperatures of the first and the second portions rises (or falls) faster than the other, and thus the one thermally contracts thermally expands) faster than the other. As a result, there exists a timing at which the total length of the member changes. By comparison, if the first and the second portions have the same thermal capacity, such a timing will not appear. Accordingly, the total length of the member (the length along the ion flight path) can always be kept constant.

It is preferable that the member for use in a mass spectrometer is a flight tube forming, inside thereof, a free flight space for the ions.

According to this mode of the present invention, since the length of the flight tube (the length along the ion flight path) does not change depending on the temperature, the constancy of the flight distance of ions is secured. Accordingly, various ions can be accurately separated with respect to each mass-to-charge ratio m/z depending on the time of flight.

It is preferable that the member for use in a mass spectrometer is an insulation spacer disposed between a plurality of electrodes arranged along the flight path.

According to this mode of the present invention, since the length of the insulation spacer (the length along the ion flight path) does not change depending on the temperature, the constancy of the intervals between the electrodes is secured. Therefore, a predetermined effect on the flying ions can be accurately obtained.

Another mode of the present invention is an insulation spacer to be disposed between a plurality of electrodes arranged along a flight path of ions in a mass spectrometer in which ions accelerated by an electric field are made to fly freely, and are separated and detected with respect to each mass-to-charge ratio depending on a time of flight taken by each ion to reach a detector, the insulation spacer including:

a first portion having a length L1 along the flight path; and

a second portion that is disposed adjacent to the first portion along the flight path, is made of a material different from a material for the first portion, and has a length L2 along the flight path, wherein

the length L1 and the length L2 are set so as to satisfy L1×α1+L2×α2+L3×α3=0,

where α1 is the linear expansion coefficient along the flight path of the material for the first portion, α2 is the linear expansion coefficient along the flight path of the material for the second portion, L3 is the length of each of the electrodes along the flight path, and α3 is the linear expansion coefficient along the flight path of the electrodes.

According to this mode of the present invention, when the length of the first portion of the insulation spacer (the length along the ion flight path) is increased by, for example, ΔL1 due to thermal expansion, and the length of the electrodes (the length along the ion flight path) is increased by, for example, ΔL3 due to thermal expansion, the amount of decrease ΔL2 in the length of the second portion due to thermal contraction is equal to ΔL1+ΔL3(−ΔL2=−L2×α2×Δθ=L1×α1×Δθ+L3×α3×Δθ=ΔL1+ΔL3). Therefore, it the electrode expands (or contracts) due to a temperature change, the constancy of the intervals between the electrodes is secured. As a result, a predetermined effect on the flying ions can be accurately obtained.

### Advantageous Effects of the Invention

In a member that is disposed along a flight path of ions and is used for forming a flight space of ions, when the length of a first portion (the length along the flight path of ions) increases by, for example, ΔL due to thermal expansion, the length of a second portion (the length along the flight path of ions) decreases by ΔL due to thermal contraction. Therefore, the total length of the member (the length along the flight path of ions) does not change. Therefore, the deterioration in analysis accuracy of a mass spectrometer due to the change in length of the member depending on the temperature can be avoided.

### BRIEF DESCRIPTION OF DRAWINGS

FIG. 1 is a diagram schematically showing a configuration of a mass spectrometer.

FIG. 2 is a sectional view of a flight tube observed from one side.

FIG. 3 is a sectional view of a portion of an acceleration electrode observed from one side.

FIG. 4 is a sectional view of a portion of an acceleration electrode according to another embodiment observed from one side.

FIG. 5 is a diagram schematically showing a configuration of a mass spectrometer according to another embodiment.

### DESCRIPTION OF EMBODIMENTS

An embodiment of the present invention is described with reference to the attached drawings.

### 1. Mass Spectrometer 100

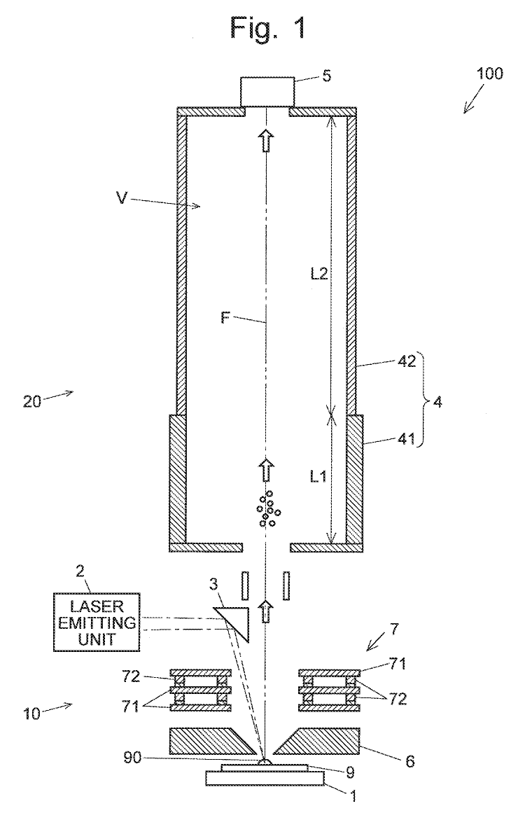

An overall configuration of a mass spectrometer 100 is described with reference to FIG. 1. FIG. 1 is a diagram schematically showing a configuration of the mass spectrometer 100.

The mass spectrometer 100 is a time-of-flight mass spectrometer (TOFMS) in which ions accelerated by an electric field are made to fly freely, are separated and detected with respect to each mass-to-charge ratio depending on the time of flight taken by each ion to reach a detector.

The mass spectrometer 100 includes an ion source 10 for generating ions. For the ion source 10, an ion source according to matrix assisted laser desorption/ionization (MALDI) method can be adopted, for example. In this case, the ion source 10 includes a stage 1 that has a top surface on which a sample plate 9 is to be placed, a laser emitting unit 2 that emits a laser beam, and a reflecting mirror 3 that reflects the laser beam to converge the light onto a sample 90 placed on the sample plate 9. Here, the ion source 10 is not limited to the MALDI ion source, but may be, for example, a laser desorption ion source, a desorption electrospray ion source, a plasma desorption ion source, and so on.

Above the stage 1, a mass spectrometer unit 20 is provided. The mass spectrometer unit 20 includes a flight tube 4 that forms a free flight space V for ions inside, and an ion detector 5. Between the stage 1 and the mass spectrometer unit 20, an extraction electrode 6 and an acceleration electrode 7 are arranged. The extraction electrode 6 forms an electric field for extracting ions generated from the sample 90 irradiated with the laser beam, upward from the vicinity of the position where the ions are generated. The acceleration electrode 7 imparts acceleration energy to the extracted ions. As a specific example, the acceleration electrode 7 includes a plurality of (typically, three) electrodes 71 arranged along an ion flight path F, with insulation spacers 72 disposed between the electrodes 71 which are adjacent to each other (i.e., einzel lens). In the example shown in the drawings, two ring-shaped insulation spacers 72 having different diameters are disposed in each space between the electrodes 71 which are adjacent to each other.

An operation of the mass spectrometer 100 is described. The sample 90 is mixed beforehand with a matrix, i.e. a substance which easily absorbs laser light and is readily ionized, and is placed on the sample plate 9. The sample 90 placed on the sample plate 9 is irradiated with the laser beam emitted from the laser emitting unit 2, whereby compounds contained in the sample 90 are ionized.

The generated ions are extracted upward by the electric field formed by the extraction electrode 6, and acceleration energy is imparted to those ions by the acceleration electrode 7 to introduce the ions into the flight tube 4. The ions introduced in the flight tube 4 fly freely in the free flight space V without being affected by any electric field, and then reach the ion detector 5. In the free flight space V, ions having smaller mass-to-charge ratios fly at higher speeds. Accordingly, various ions that have started flying approximately at the same will sequentially reach the detector 5 and be detected in the order of increasing mass-to-charge ratio.

In the mass spectrometer unit 20, various ions accelerated almost at once by the electric field are introduced into the free flight space V formed inside the flight tube 4, and are separated by mass (strictly, by mass-to-charge ratio m/z) based on the time taken for each ion to fly in the free flight space V and reach the ion detector 5 (time of flight). The ion detector 5 continuously produces detection signals corresponding to the amount of incoming ions. Therefore, the time of flight can be converted into mass, and a mass spectrum with the horizontal axis indicating the mass and the vertical axis indicating the signal intensity can be created.

### <2. Member Disposed Along Ion Flight Path F>

As mentioned above, the mass spectrometer 100 includes various members disposed along the ion flight path F. The members disposed along the ion flight path F are often used for forming a flight space of ions, for example. In such a case, the change in length (i.e., length along an ion flight path: hereinafter the term “length” indicates “the length along the ion flight path F” unless otherwise specifically noted) of the members depending on the temperature often causes problems. For example, the flight tube 4 and the insulation spacer 72 of the acceleration electrode 7 correspond to such members.

For example, the mass-to-charge ratio m/z based on the time of flight cannot be accurately determined unless the free-flight distance of the ions is constant. Accordingly, if the length of the flight tube 4 changes depending on the temperature, the mass-to-charge ratio m/z cannot be accurately determined.

As another example, if the intervals between a plurality of (three in the example shown in the drawings) electrodes 71 disposed along the ion flight path F are not constant, a predetermined lens effect on the ions (for example, acceleration) cannot be obtained. Accordingly, if the length of the insulation spacer 72 disposed between electrodes 71 changes, the mass-to-charge ratio m/z cannot be accurately determined, either.

The mass spectrometer 100 includes the flight tube 4 and the insulation spacer 72, which are disposed along the ion flight path F. Both the flight tube 4 and the insulation spacer 72 are a type of member which can cause a problem due to a change in its length depending on the temperature. In view of this problem, the flight tube 4 and the insulation spacer 72 are each composed of a first portion and a second portion that is disposed adjacent to the first portion along the ion flight path F, and is made of a material different from that of the first portion. With this, the lengths of the flight tube 4 and the insulation spacer 72 are prevented from changing depending on the temperature. The specific structures of the flight tube 4 and the insulation spacer 72 will hereinafter described.

<2-1. Flight Tube 4>

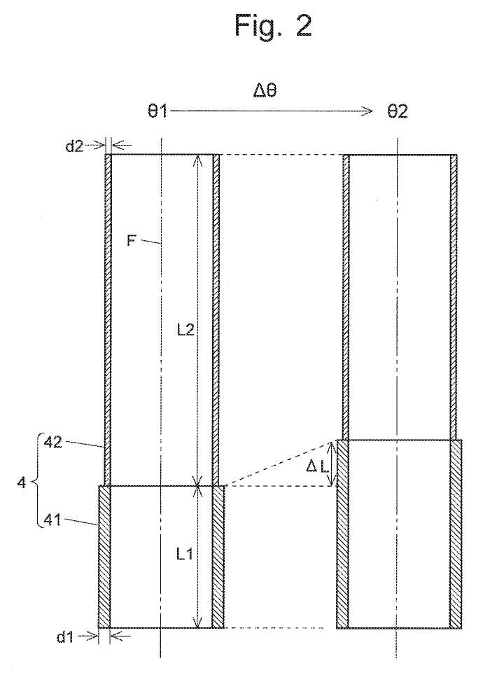

FIG. 2 is a sectional view of the flight tube 4 observed from one side. As shown in FIG. 2, the flight tube 4 is formed by a first portion 41 and a second portion 42 which are connected along the extending direction of the flight tube 4 (i.e., along the ion flight path F). Specifically, the first portion 41 and the second portion 42 each have a straight cylinder shape. The first portion 41 and the second portion 42 are coaxially arranged and connected, for example, by welding one end of the former portion to one end of the latter portion.

Either the material for the first portion 41 (hereinafter referred to as the “first material”) or the material for the second portion 42 (hereinafter referred to as the “second material”) has a positive linear expansion coefficient, and the other has a negative linear expansion coefficient. Specific examples of the material having the negative linear expansion coefficient include: bismuth lanthanoid nickel oxide (Bi₁₋ₓLnₓNiO₃), bismuth nickel iron oxide (BiNi₁₋ₓFeₓO₃), silicon oxide, manganese nitride, nickel oxide, zirconium tungstate, tungsten oxide, aluminum titanate, iron oxide, carbon fiber, and others.

The length of the first portion 41 along the ion flight path F (denoted by “L1”), and the length of the second portion 42 along the ion flight path F (denoted by “L2”) are set to satisfy the following equation:

L1×α1+L2×α2=0 (Equation 1)

where α1 is the linear expansion coefficient of the first material (the linear expansion coefficient along the ion flight path F), and α2 is the linear expansion coefficient of the second material (the linear expansion coefficient along the ion flight path F). When the linear expansion coefficient is given by “α=(dL/dθ)/Lθ” (where θ, L, and L₀ respectively indicate the temperature, length, and length at 0° C.), L1 in Equation 1 corresponds to the length of the first portion 41 at 0° C., and L2 corresponds to the length of the second portion 42 at 0° C.

Accordingly, as shown in the drawings, when the length of the first portion 41 increases by ΔL due to thermal expansion caused by temperature change Δθ, for example, the length of the second portion 42 decreases by the same amount, ΔL, due to thermal contraction (ΔL=L1×α1×Δθ=−L2×α2×Δθ). In other words, the amount of thermal expansion of the first portion 41 is cancelled by that of the thermal contraction of the second portion 42. Thus, the total length of the flight tube 4 does not change. Since the length of the flight tube 4 does not change depending on the temperature, the constancy in flight distance of the ions is secured. This allows various ions to be accurately separated with respect to each mass-to-charge ratio m/z depending on the time of flight, in the mass spectrometer 100.

In this flight tube 4, the thermal capacity of the first portion 41 and that of the second portion 42 are made to be equal to each other, for example, by adjusting thickness d1 of the first portion 41 (the thickness in a direction orthogonal to the length direction, and the same applies to the following) and thickness d2 of the second portion 42 relative to each other.

Accordingly, when an ambient temperature changes from θ1 to θ2, for example, the speed of temperature change in the first portion 41 is equal to that in the second portion 42. In other words, the temperature of the first portion 41 is always kept approximately equal to that of the second portion 42, not only during a time period in which the temperatures of the first portion 41 and the second portion 42 are maintained at a constant level (a time period in which the temperatures are in an equilibrium state), but also during a time period in which the temperatures of the first portion 41 and the second portion 42 are changing (a time period in which the temperatures are in a non-equilibrium state). If the thermal capacities of the first portion 41 and the second portion 42 were significantly different, one of the temperatures of the first portion 41 and the second portion 42 would rises (or falls) faster than the other, causing one of the two portions to thermally contract (or thermally expand) faster than the other. As a result, there exists a timing at which the total length of the flight tube changes. In the case of the present embodiment, such a timing will not appear, since the thermal capacity of the first portion 41 is equal to that of the second portion 42. This means that the total length of the flight tube 4 can always be kept constant.

2-2. Insulation Spacer 72>

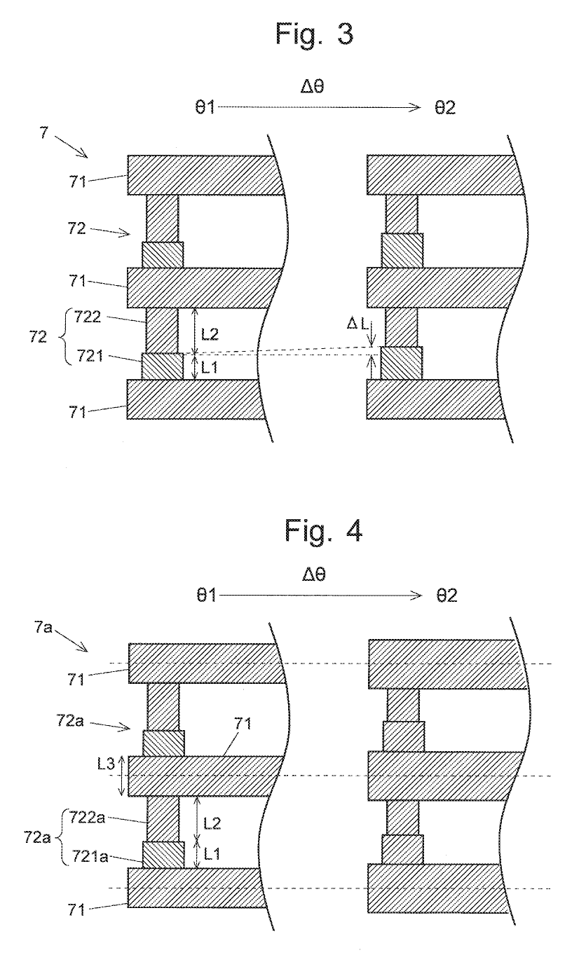

FIG. 3 is a sectional view of a portion of the acceleration electrode 7 observed from one side. As mentioned above, the acceleration electrode 7 includes three electrodes 71 arranged along its extending direction (i.e., along the ion flight path F), with the insulation spacers 72 disposed between the electrodes 71 which are adjacent to each other. The insulation spacers 72 are used for insulating the electrodes 71 from each other as well as positioning them.

Each of the insulation spacers 72 is formed by a first portion 721 and a second portion 722 which are connected along the extending direction of the insulation spacer 72 (i.e., along the ion flight path F). Specifically, the first portion 721 and the second portion 722 each have a ring shape in a plan view with a uniform thickness. One of the main surfaces of the first portion 721 is joined to one of the main surfaces of the second portion 722 by, for example, welding.

Regarding the insulation spacer 72, either the material for the first portions 721 (first material) or the material for the second portions 722 (second material) also has a positive linear expansion coefficient, and the other has a negative linear expansion coefficient, as with the flight tube 4. The length of the first portion 721 along the ion flight path F (denoted by “L1”), and that of the second portion 722 along the ion flight path F (denoted by “L2”) are set to satisfy Equation 1 mentioned earlier, where α1 is the linear expansion coefficient of the first material (the linear expansion coefficient along the flight path F) and α2 is the linear expansion coefficient of the second material (the linear expansion coefficient along the flight path F). For convenience of description, the length of the first portion 721 is denoted by L1, as with the length of the first portion 41 of the flight tube 4 described earlier, which is also denoted by L1. Needless to say, the length of the first portions 721 of the insulation spacer 72 may be different from that of the first portion 41 of the flight tube 4. The same also applies to L2, as well as to the following descriptions.

Accordingly, as shown in the drawings, when the length of the first portion 721 increases by ΔL due to thermal expansion caused by temperature change Δθ, for example, the length of the second portion 722 decreases by ΔL due to thermal contraction (ΔL=L1×α1×Δθ=—L2×α2×Δθ). In other words, the amount of thermal expansion of the first portion 721 is cancelled by the amount of thermal contraction of the second portion 722. Thus, the total length of the insulation spacer 72 does not change. Since, the length of the insulation spacer 72 does not change depending on the temperature, the constancy of the intervals between the electrodes 71 is secured. Therefore, a predetermined effect on the flying ions can be accurately obtained.

As with the flight tube 4, in the insulation spacer 72, it is preferable that the thermal capacity of the first portion 721 and that of the second portion 722 are made to be equal to each other, for example, by adjusting the cross-sectional area of the first portion 721 (the cross-sectional area at a plane orthogonal to the length direction, and the same applies to the following) and that of the second portion 722 relative to each other. With this configuration, the temperature of the first portion 721 is always kept approximately equal to that of the second portion 722, not only during a time period in which the temperatures of the first portion 721 and the second portion 722 are maintained at a constant level, but also during a time period in which the temperatures of the first portion 721 and the second portion 722 are changing, as mentioned above. Accordingly, the total length of the insulation spacer 72 (consequently, the intervals between the electrodes 71) can always be kept constant.

<2-3. Insulation Spacer 72a>

FIG. 4 is a sectional view showing a portion of an acceleration electrode 7a that includes the insulation spacers 72a according to another embodiment observed from one side. Each of the insulation spacers 72a is also formed by a first portion 721a and a second portion 722a connected in the extending direction of the insulation spacer 72a (i.e., along the ion flight path F), as with the above-mentioned insulation spacer 72.

Regarding the insulation spacer 72a, either the material for the first portion 721a (first material) or the material for the second portion 722a (second material) also has a positive linear expansion coefficient, and the other has a negative linear expansion coefficient, as in the aforementioned insulation spacer 72. The length of the first portion 721a along the ion flight path F (denoted by “L1”) and the length of the second portion 722a along the ion flight path F (denoted by “L2”) are set to satisfy the following equation:

L1×α1+L2×α2+L3×α3=0 (Equation 2)

where α1 is the linear expansion coefficient of the first material (the linear expansion coefficient along the flight path F), α2 is the linear expansion coefficient of the second material (the linear expansion coefficient along the flight path F), L3 is the length of each of the electrodes 71 along the ion flight path F, and α3 is the linear expansion coefficient of the electrode 71 (linear expansion coefficient along the flight path F).

Accordingly, for example, when temperature change Δθ has caused an increase in the length of the first portion 721a by ΔL due to thermal expansion as well as an increase in the length of electrode 71 by ΔL3 due to thermal expansion, the length of the second portion 722a decreases by ΔL2 that is equal to the value obtained by ΔL1+ΔL3 (−ΔL2=−L2×α2×Δθ=L1×α1×Δθ+L3×α3×Δθ=ΔL1+ΔL3). This means that the constancy of the intervals between the electrodes 71 is secured if the electrode 71 expands (or contracts) due to a temperature change. Therefore, a predetermined effect on the flying ions can be accurately obtained.

In the insulation spacer 72a, it is preferable that the thermal capacities of the first portion 721a, second portion 722a, and each of electrodes 71 are made to be equal to one another, for example, by adjusting the cross-sectional area of each of the first portion 721a and the second portion 722a. With this configuration, the temperatures of the first portion 721a, the second portion 722a, and each of the electrodes 71 are always kept approximately equal to one another, not only during a time period in which the temperatures of the first portion 721a and the second portion 722a, and each of the electrodes 71 are maintained at a constant level, but also during a time period in which the temperatures of the first portion 721a and the second portion 722a, and each of the electrodes 71 are changing. Accordingly, the intervals of the electrodes 71 can always be kept constant.

### 3. Other Embodiments

Although the mass spectrometer 100 according to the above-mentioned embodiment is configured to make ions fly linearly in the free flight space V (the so-called linear TOFMS), the present invention can also be applied in a mass spectrometer in which the flight trajectory of the ions is inverted halfway (the so-called reflectron TOFMS), or a mass spectrometer in which ions are made to repeatedly fly in a loop orbit (the so-called multiturn TOFMS).

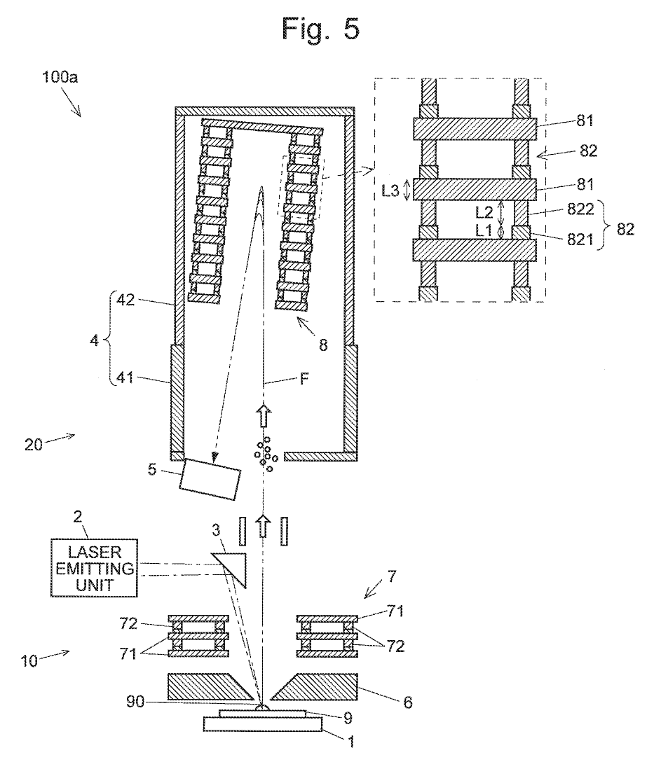

FIG. 5 schematically shows a configuration example of a mass spectrometer 100a in which the flight trajectory of ions is inverted halfway. Structural components identical with those included in the mass spectrometer 100 according to the above-mentioned embodiment are denoted by reference signs identical with those in the mass spectrometer 100 in the drawings, and descriptions of such components will be omitted.

The mass spectrometer 100a includes a reflectron (reflector) 8 that returns ions during their flight by the effect of a direct-current electric field. As a specific example, the reflectron 8 has a structure in which a plurality of plate-shaped electrodes 81 each of which is provided with a hole at its center are arranged at regular intervals, with insulation spacers 82 sandwiched in between. On the respective electrodes 81 are applied voltages created, for example, by using a series of resistors, in such a manner that the potential increases with an increase in the distance from the ion source 10. With this configuration, a gradient electric field is formed inside the reflectron 8. After flying through the free flight space V, the ions entering the reflectron 8 are reflected by the gradient electric field.

The insulation spacers 82 included in the reflectron 8 are also arranged along the ion flight path F in the same manner as with the above-mentioned flight tube 4 and insulation spacer 72. Accordingly, the insulation spacer 82 is also a type of member which can cause a problem due to a change in its length depending on the temperature. In view of this, each of the insulation spacers 82 includes a first portion and a second portion that is disposed adjacent to the first portion along the ion flight path F, and is made of a material different from that of the first portion. Thus, the length of the insulation spacer 82 is prevented from changing due to the temperature.

Specifically, each of the insulation spacers 82 is formed by a first portion 821 and a second portion 822 which are connected along the extending direction of the insulation spacer 82 (i.e., along the ion flight path F). The first portion 821 and the second portion 822 each have a ring shape in a plan view with a uniform thickness. One of the main surfaces of the first portion 821 is joined to one of the main surfaces of the second portion 822 by, for example, welding.

Regarding the insulation spacer 82, either the material for the first portion 821 (first material) or the material for the second portion 822 (second material) also has a positive linear expansion coefficient, and the other has a negative linear expansion coefficient, as with the flight tube 4 and others. The length of the first portion 821 along the ion flight path F (denoted by “L1”), and the length of the second portion 822 along the ion flight path F (denoted by “L2”) are set to satisfy Equation 1 mentioned earlier, where α1 is the linear expansion coefficient of the first material (a linear expansion coefficient along the flight path F), and α2 is the linear expansion coefficient of the second material (a linear expansion coefficient along the flight path F). Accordingly, the total length of the insulation spacer 82 does not change if a temperature change occurs. Thus, the constancy of the intervals between the electrodes 81 is secured.

The length L1 of the first portion 821 along the ion flight path F, and the length L2 of the second portion 822 along the ion flight path F may also be set to satisfy Equation 2 mentioned earlier, where α1 is the linear expansion coefficient of the first material (a linear expansion coefficient along the flight path F), α2 is the linear expansion coefficient of the second material (a linear expansion coefficient along the flight path F), L3 is the length of each of the electrodes 81 along the ion flight path F, and α3 is the linear expansion coefficient of the electrode 81 (a linear expansion coefficient along the flight path F). In this case, the constancy of the intervals of the electrodes 81 is secured, as mentioned above, if the electrode 81 expands (or contracts) due to a temperature change.

Regarding the insulation spacers 82, it is preferable that the thermal capacity of the first portion 821 and that of the second portion 822 are made to be equal to each other, for example, by adjusting the cross-sectional area of the first portion 821 and that of the second portion 822 relative to each other. This configuration ensures that the temperature of the first portion 821 is always kept approximately equal to the temperature of the second portion 822, as mentioned above. Accordingly, the total length of the insulation spacers 82 can always be kept constant.

It is also preferable that the thermal capacities of the first portion 821, second portion 822, and each of the electrodes 81 are made to be equal to one another, for example, by adjusting the cross-sectional area of each of the first portion 821 and the second portion 822. This configuration ensures that the temperatures of the first portion 821, the second portion 822, and each of the electrodes 81 are always kept approximately equal to one another, as mentioned above. Accordingly, the intervals between the electrodes 81 can always be kept constant.

### REFERENCE SIGNS LIST

1 . . . Stage
2 . . . Laser Emitting Unit
3 . . . Reflecting Mirror
4 . . . Flight Tube
41 . . . First Portion
42 . . . Second Portion
5 . . . Ion Detector
6 . . . Extraction Electrode
7, 7a . . . Acceleration Electrode
71 . . . Electrode
72, 72a . . . Insulation Spacer
721, 721a . . . First Portion
722, 722a . . . Second Portion
8 . . . Reflectron
81 . . . Electrode
82 . . . Insulation Spacer
821 . . . First Portion
822 . . . Second. Portion
10 . . . Ion Source
20 . . . Mass Spectrometer Unit
100, 100a . . . Mass Spectrometer
L1 . . . Length of First Portion along Flight Path
L2 . . . Length of Second Portion along Flight Path
L3 . . . Length of Electrode along Flight Path
α1 . . . linear Expansion Coefficient of First Material along Flight Path
α2 . . . Linear Expansion Coefficient of Second Material along Flight Path
α3 . . . Linear Expansion Coefficient of Electrode along Flight Path
F . . . Flight Path

1. A member for use in a mass spectrometer, the member configured to be disposed along a flight path of ions in a mass spectrometer in which ions accelerated by an electric field are made to fly freely, and are separated and detected with respect to each mass-to-charge ratio depending on a time of flight taken by each ion to reach a detector, the member comprising:
a first portion having a length L1 along the flight path; and
a second portion that is disposed adjacent to the first portion along the flight path, is made of a material different from a material for the first portion, and has a length L2 along the flight path, wherein,
the length L1 and the length L2 are set so as to satisfy L1×α1+L2×α2=0,
where α1 is a linear expansion coefficient along the flight path of the material for the first portion, and α2 is a linear expansion coefficient along the flight path of the material for the second portion.

2. The member for use in a mass spectrometer according to claim 1, wherein
a thermal capacity of the first portion and a thermal capacity of the second portion are equal to each other.

3. The member for use in a mass spectrometer according to claim 1, wherein
the member is a flight tube forming, inside thereof, a free flight space for ions.

4. The member for use in a mass spectrometer according to claim 2, wherein
the member is a flight tube forming, inside thereof, a free flight space for ions.

5. The member for use in a mass spectrometer according to claim 1, wherein
the member is an insulation spacer disposed between a plurality of electrodes arranged along the flight path.

6. The member for use in a mass spectrometer according to claim 2, wherein
the member is an insulation spacer disposed between a plurality of electrodes arranged along the flight path.

7. An insulation spacer to be disposed between a plurality of electrodes arranged along a flight path of ions in a mass spectrometer in which ions accelerated by an electric field are made to fly freely, and are separated and detected with respect to each mass-to-charge ratio depending on a time of flight taken by each ion to reach a detector, the insulation spacer comprising:
a first portion having a length L1 along the flight path; and
a second portion that is disposed adjacent to the first portion along the flight path, is made of a material different from a material for the first portion, and has a length L2 along the flight path, wherein
the length L1 and the length L2 are set so as to satisfy L1/α1+L2×α2+L3×α3=0,
where α1 is a linear expansion coefficient along the flight path of the material for the first portion, α2 is a linear expansion coefficient along the flight path of the material for the second portion, L3 is a length of each of the electrodes along the flight path, and α3 is a linear expansion coefficient of the electrodes along the flight path.
